(19) United States
(12) Patent Application Publication
(10) Pub. No.: US 2019/0341809 A1
(43) Pub. Date: Nov. 7, 2019

(54) NON-CONTACT POWER SUPPLY DEVICE

(71) Applicant: Omron Corporation, Kyoto (JP)

(72) Inventors: Goro Nakao, Aichi (JP); Toshiyuki Zaitsu, Kyoto (JP)

(73) Assignee: Omron Corporation, Kyoto (JP)

(21) Appl. No.: 16/344,712

(22) PCT Filed: Oct. 27, 2017
(86) PCT No.: PCT/JP2017/038994

§ 371 Date: Apr. 24, 2019

(30) Foreign Application Priority Data
Jan. 13, 2017 (JP) 2017-004527

(51) Int. Cl. H02J 50/12; H02J 5/00; H02J 50/50

(52) U.S. Cl. CPC H02J 50/12; H02J 50/50; H02J 5/005

(57) ABSTRACT

In a non-contact power supply device, a power reception device includes a first resonant circuit that resonates at a first frequency, a voltage detection circuit that measures an output voltage from the first resonant circuit to obtain a measurement value of the output voltage, and a transmitter that transmits a signal including information representing the measurement value to a power transmission device. The power transmission device includes a second resonant circuit that resonates at a second frequency lower than the first frequency, a power supply circuit that supplies AC power having an adjustable switching frequency to the second resonant circuit, a receiver that receives the signal including the information representing the measurement value, and a control circuit that controls the switching frequency in accordance with the measurement value, such that the second resonant circuit and the power supply circuit continue a soft switching operation.

### FIELD

The present invention relates to a non-contact power supply device.

### BACKGROUND

Conventionally, so-called non-contact power supplying (also referred to as wireless power feeding) technology to transfer electric power through space, rather than through a metal contact or the like, has been researched.

As a type of the non-contact power supplying technology, a power feeding method using electromagnetic induction is known. As the power feeding method using electromagnetic induction, a primary series and secondary (power reception side) parallel capacitor method (hereinafter referred to as SP method) is used (for example, refer to Non-Patent Literature 1). In the SP method, a capacitor is connected in series with a transmission coil, which operates as a part of a transformer, on a primary side (power transmission side), and another capacitor is connected in parallel with a reception coil, which operates as another part of the transformer, on a secondary side (power reception side).

In the SP method, since a resonant circuit constituted of the reception coil and the capacitor on the power reception side resonates in parallel, the resonant circuit outputs a constant current output. Accordingly, the SP method is generally difficult to control, as compared with a primary series and secondary series capacitor method (hereinafter referred to as SS method), which outputs a constant voltage output on its power reception side. This is because general electronic equipment is controlled with a constant voltage. If series resonance on the power transmission side is used for electric power transfer, in a state in which the degree of coupling between the transmission coil on the power transmission side and the reception coil on the power reception side is extremely low (for example, the degree of coupling k<0.2), a resonant current on the power transmission side increases at the time of power feeding, and energy transfer efficiency deteriorates. Therefore, in applications in which a high degree of coupling cannot be maintained, it is preferable not to use series resonance on the power transmission side for electric power transfer. When not using series resonance on the power transmission side, using parallel resonance on the power reception side allows transferring higher electric power. Therefore, in the case of an extremely low degree of coupling, the non-contact power supply device preferably has a circuit configuration such that the resonant circuit on the power reception side mainly takes charge of electric power transfer. In other words, adopting a circuit configuration of the SP method, rather than the SS method, enables an increase in the efficiency of electric power transfer.

In the SP method, a method for outputting a constant output voltage from the power reception side by setting the capacities of the capacitors of the resonant circuits on the power transmission side and the power reception side at appropriate values has been proposed (for example, refer to Non-Patent Literature 2).

### CITATION LIST

### Non Patent Literature

[NPL 1] Tohi et al. “Maximum Efficiency of Contactless Power Transfer Systems using k and Q”, Conference Paper of the Institute of Electrical Engineers of Japan. SPC, Technical Committee on Semiconductor Power Converter, 2011
[NPL 2] Fujita et al. “Contactless Power Transfer Systems using Series and Parallel Resonant Capacitors”, the Transactions of the Institute of Electrical Engineers of Japan. D (the Transactions of Industrial Applications), Vol. 127, No. 2, pp. 174-180, 2007

### SUMMARY

### Technical Problem

However, even in the technology disclosed in Non-Patent Document 2, since the capacities of the capacitors of the resonant circuits to output the constant output voltage depend on the degree of coupling, when the non-contact power supply device is used in an environment in which the degree of coupling dynamically changes, this technology is difficult to apply.

Therefore, the present invention aims to provide a non-contact power supply device that can prevent a reduction in energy transfer efficiency, even if the degree of coupling between a transmission coil and a reception coil dynamically changes.

### Solution to Problem

As an aspect of the present invention, a non-contact power supply device that includes a power transmission device and a power reception device to which electric power is contactlessly transferred from the power transmission device is provided. In the non-contact power supply device, the power reception device includes a first resonant circuit which includes a reception coil for receiving the electric power from the power transmission device, and a first resonant capacitor connected in parallel with the reception coil, and resonates at a first frequency; a voltage detection circuit which measures an output voltage from the first resonant circuit to obtain a measurement value of the output voltage; and a transmitter which transmits a signal including information representing the measurement value of the output voltage to the power transmission device. The power transmission device includes a second resonant circuit which includes a transmission coil for supplying the electric power to the power reception device, and a second resonant capacitor connected in series with the transmission coil, and resonates at a second frequency lower than the first frequency; a power supply circuit which supplies AC power having an adjustable switching frequency to the second resonant circuit; a receiver which receives the signal including the information representing the measurement value of the output voltage; and a control circuit which controls the switching frequency in accordance with the measurement value of the output voltage, such that the second resonant circuit and the power supply circuit continue soft switching operation.

In the non-contact power supply device, the control circuit of the power transmission device preferably controls the switching frequency within a frequency range that includes the first frequency in a presumed degree of coupling between the transmission coil and the reception coil and does not include the second frequency in the presumed degree.

In this case, the frequency range in which the switching frequency is controlled is preferably set such that a lower limit frequency of the frequency range coincides with the first frequency at a minimum value of the presumed degree of coupling. When the measurement value of the output voltage exceeds a first voltage, the control circuit preferably sets the switching frequency at an upper limit frequency of the frequency range.

In the contactless power feeing system, the control circuit of the power transmission device preferably controls the switching frequency so as to reduce the difference between the measurement value of the output voltage and the output voltage when the first resonant circuit resonates.

### Advantageous Effects of Invention

The non-contact power supply device according to the present invention has the effect of preventing a reduction in energy transfer efficiency, even if the degree of coupling between the transmission coil and the reception coil dynamically changes.

### BRIEF DESCRIPTION OF DRAWINGS

FIG. 1A is a view illustrating an example of the frequency response of the output voltage of a power reception side resonant circuit in an SP method, when a resonant frequency of the power reception side resonant circuit is higher than a resonant frequency of a power transmission side resonant circuit.

FIG. 1B is a view illustrating an example of the frequency response of the output voltage of the power reception side resonant circuit in the SP method, when the resonant frequency of the power reception side resonant circuit and the resonant frequency of the power transmission side resonant circuit are approximately the same.

FIG. 2A illustrates the frequency response of a current flowing through a transmission coil, when power transmission side and power reception side resonant circuits are identical to the resonant circuits of FIG. 1A.

FIG. 2B illustrates the frequency response of a current flowing through a transmission coil, when power transmission side and power reception side resonant circuits are identical to the resonant circuits of FIG. 1B.

FIG. 3 is a schematic configuration view of a non-contact power supply device according to an embodiment of the present invention.

FIG. 4 is a view illustrating an example of the relationship between control of a switching frequency and the frequency response of an output voltage on a degree of coupling basis.

### DETAILED DESCRIPTION OF INVENTION

A non-contact power supply device according to an embodiment of the present invention will be described below with reference to the drawings. The non-contact power supply device feeds electric power from a power transmission device to a power reception device in accordance with the SP method. The inventors have noted that when a resonant frequency of a resonant circuit of the power transmission device and a resonant frequency of a resonant circuit of the power reception device are brought close to each other, maximum feedable power increases, but especially in a case where the degree of coupling is low, a current flowing through a transmission coil included in the resonant circuit of the power transmission device also increases, whereby energy transfer efficiency is not necessarily improved.

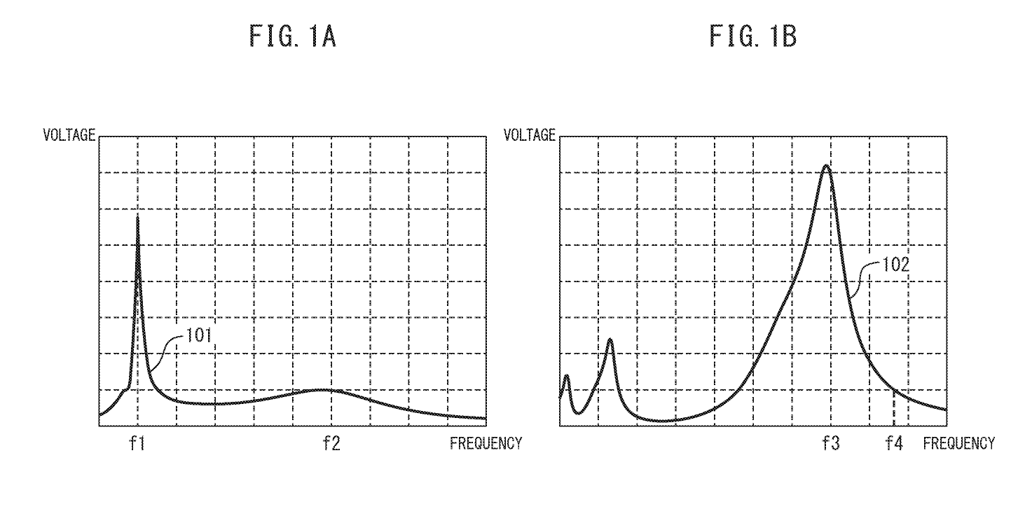

FIG. 1A is a view illustrating an example of the frequency response of the output voltage of a power reception side resonant circuit in the SP method, when a resonant frequency of the power reception side resonant circuit is higher than a resonant frequency of a power transmission side resonant circuit. FIG. 1B is a view illustrating an example of the frequency response of the output voltage of the power reception side resonant circuit in the SP method, when a resonant frequency of the power reception side resonant circuit and a resonant frequency of the power transmission side resonant circuit are approximately the same. In FIGS. 1A and 1B, the horizontal axes represent frequency, and the vertical axes represent voltage. In FIG. 1A, graph 101 represents the frequency response of the output voltage of the power reception side resonant circuit, when the resonant frequency of the power reception side resonant circuit is higher than the resonant frequency of the power transmission side resonant circuit. In FIG. 1B, graph 102 represents the frequency response of the output voltage of the power reception side resonant circuit, when the resonant frequency of the power reception side resonant circuit and the resonant frequency of the power transmission side resonant circuit are approximately the same, in the SP method. As represented by the graph 101, when the resonant frequency of the power reception side resonant circuit is higher than the resonant frequency of the power transmission side resonant circuit, the output voltage is at its peak at the resonant frequency f1 of the power transmission side resonant circuit or the resonant frequency f2 of the power reception side resonant circuit. On the other hand, when the resonant frequency of the power transmission side resonant circuit and the resonant frequency of the power reception side resonant circuit are approximately the same, as represented by the graph 102, the output voltage is at its peak at the common resonant frequency f3 between the power transmission side and the power reception side. The peak voltage is higher than any peak voltage in cases where the resonant frequency of the power reception side resonant circuit is higher than the resonant frequency of the power transmission side resonant circuit.

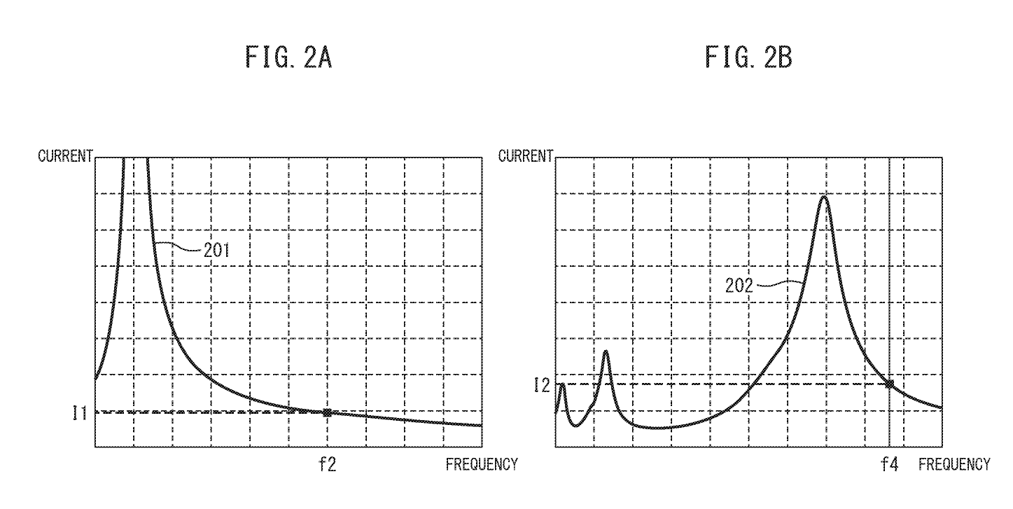

FIG. 2A illustrates the frequency response of a current flowing through a transmission coil of a power transmission side resonant circuit, when the power transmission side and power reception side resonant circuits are identical to the resonant circuits of FIG. 1A. FIG. 2B illustrates the frequency response of a current flowing through a transmission coil of the power transmission side resonant circuit, when the power transmission side and power reception side resonant circuits are identical to the resonant circuits of FIG. 1B. In FIGS. 2A and 2B, the horizontal axes represent frequency, and the vertical axes represent current. In FIG. 2A, graph 201 represents the frequency response of the current flowing through the transmission coil, which corresponds to the frequency response of the output voltage of the power reception side resonant circuit represented in FIG. 1A. In FIG. 2B, graph 202 represents the frequency response of the current flowing through the transmission coil, which corresponds to the frequency response of the output voltage of the power reception side resonant circuit represented in FIG. 1B. As represented by the graphs 201 and 202, even if the output voltage of the power reception side resonant circuit is the same, a higher current flows through the transmission coil when the resonant frequency of the power transmission side resonant circuit and the resonant frequency of the power reception side resonant circuit are approximately the same. For example, as represented by graphs 101 and 102, the output voltage at the resonant frequency f2 on the power reception side when the resonant frequency of the power reception side resonant circuit is higher than the resonant frequency of the power transmission side resonant circuit, is approximately the same as the output voltage at the resonant frequency f4 when the resonant frequency of the power transmission side resonant circuit and the resonant frequency of the power reception side resonant circuit are approximately the same. Conversely, as represented by graphs 201 and 202, a current value I2 flowing through the transmission coil at the resonant frequency f4 when resonant frequency of the power transmission side resonant circuit and the resonant frequency of the power reception side resonant circuit are approximately the same, is higher than a current value I1 flowing through the transmission coil at the resonant frequency f2 when the resonant frequency of the power reception side resonant circuit is higher than the resonant frequency of the power transmission side resonant circuit. Accordingly, it can be understood that that setting the resonant frequency of the power reception side resonant circuit higher than the resonant frequency of the power transmission side resonant circuit, rather than equalizing the resonant frequency of the power transmission side resonant circuit and the resonant frequency of the power reception side resonant circuit, serves to improve energy transfer efficiency. This is because when the resonant frequency of the power transmission side resonant circuit and the resonant frequency of the power reception side resonant circuit are the same, the lower the degree of coupling between the transmission coil and the reception coil, the lower the mutual inductance between the transmission coil and the reception coil, which thus results in an increase in a current flowing through the transmission coil, irrespective of load.

Accordingly, in the non-contact power supply device, each circuit element constant of the power transmission side and power reception side resonant circuits is set such that the resonant frequency of the power reception side resonant circuit is higher than the resonant frequency of the power transmission side resonant circuit. The non-contact power supply device controls a switching frequency of the power transmission side resonant circuit within a frequency range that includes the resonant frequency of the power reception side resonant circuit and does not include the resonant frequency of the power transmission side resonant circuit, which is set in accordance with the presumed degree of coupling, in order to suppress a current flowing through the transmission coil. Furthermore, the non-contact power supply device measures the output voltage of the power reception side resonant circuit, and controls the switching frequency such that the measurement value of the output voltage does not exceed a predetermined threshold value. Therefore, the non-contact power supply device enables the power transmission side resonant circuit to continue soft switching operation.

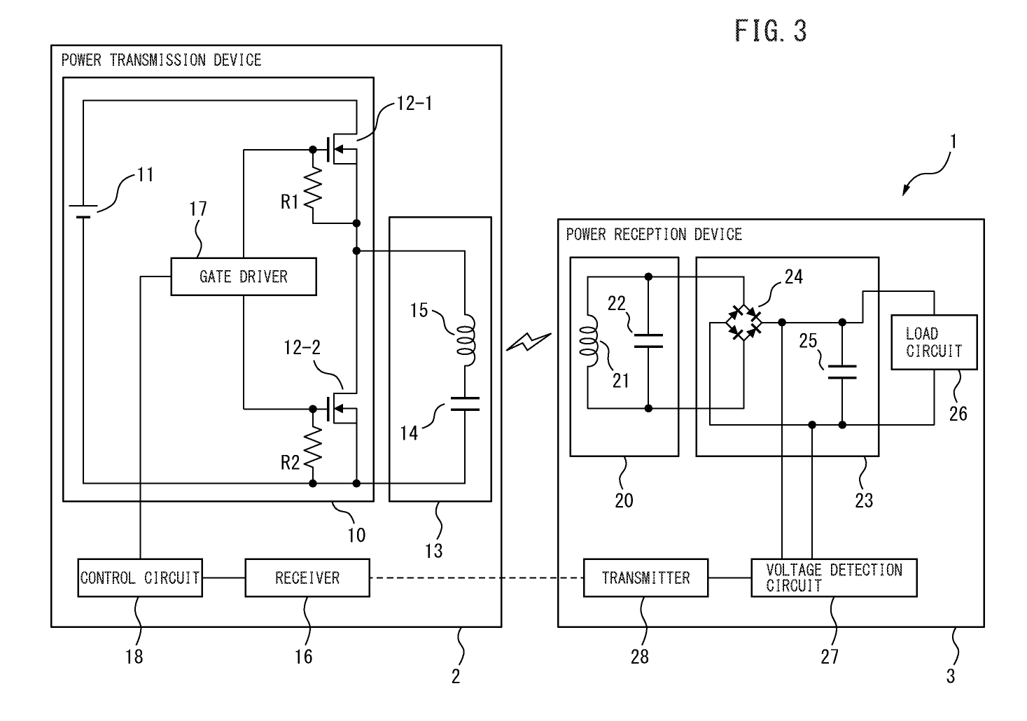

FIG. 3 is a schematic configuration view of a non-contact power supply device according to an embodiment of the present invention. As illustrated in FIG. 3, the non-contact power supply device 1 includes a power transmission device 2 and a power reception device 3 to which electric power is fed from the power transmission device 2 through space. The power transmission device 2 includes a power supply circuit 10, a resonant circuit 13 including a capacitor 14 and a transmission coil 15, a receiver 16, a gate driver 17, and a control circuit 18. On the other hand, the power reception device 3 includes a resonant circuit 20 including a reception coil 21 and a capacitor 22, a rectifying and smoothing circuit 23, a load circuit 26, a voltage detection circuit 27, and a transmitter 28.

First, the power transmission device 2 will be described.

The power supply circuit 10 supplies AC power having an adjustable switching frequency to the resonant circuit 13. Thus, the power supply circuit 10 includes a DC power supply 11 and two switching elements 12-1 and 12-2.

The DC power supply 11 supplies DC power having a predetermined voltage. Thus, the DC power supply 11 may include, for example, a battery. Alternatively, the DC power supply 11 may include a full-wave rectifying circuit and a smoothing capacitor, which are connected to a utility AC power supply and which convert AC power supplied from the AC power supply into DC power.

The two switching elements 12-1 and 12-2 are connected in series between a positive terminal and a negative terminal of the DC power supply 11. In the present embodiment, the switching element 12-1 is connected to a positive side of the DC power supply 11, while the switching element 12-2 is connected to a negative side of the DC power supply 11. Each of the switching elements 12-1 and 12-2 may be, for example, an n-channel MOSFET. A drain terminal of the switching element 12-1 is connected to the positive terminal of the DC power supply 11, and a source terminal of the switching element 12-1 is connected to a drain terminal of the switching element 12-2. A source terminal of the switching element 12-2 is connected to the negative terminal of the DC power supply 11. Furthermore, the source terminal of the switching element 12-1 and the drain terminal of the switching element 12-2 are connected to one end of the transmission coil 15 through the capacitor 14, and the source terminal of the switching element 12-2 is directly connected to the other end of the transmission coil 15.

Gate terminals of the switching elements 12-1 and 12-2 are connected to the control circuit 18 through the gate driver 17. Furthermore, the gate terminals of the switching elements 12-1 and 12-2 are connected to their source terminals through resistors R1 and R2, respectively, in order to ensure that each switching element activates upon application of an activation voltage. The switching elements 12-1 and 12-2 are alternately turned on and off at the adjustable switching frequency in accordance with a control signal from the control circuit 18. The DC power supplied from the DC power supply 11 is thereby converted into AC power by the charging and discharging of the capacitor 14, and the AC power is supplied to the resonant circuit 13 constituted of the capacitor 14 and the transmission coil 15.

The resonant circuit 13 is an example of a second resonant circuit, and is an LC resonant circuit constituted of the capacitor 14 and the transmission coil 15 connected in series with each other.

One end of the capacitor 14 is connected to one end of the transmission coil 15, and the other end of the capacitor 14 is connected to the negative terminal of the DC power supply 11 and the source terminal of the switching element 12-2. The other end of the transmission coil 15 is connected to the source terminal of the switching element 12-1 and the drain terminal of the switching element 12-2. Note that, the order of connection of the capacitor 14 and the transmission coil 15 may be reversed.

The resonant circuit 13 transfers the AC power supplied from the power supply circuit 10 to the resonant circuit 20 of the power reception device 3 through space.

Whenever the receiver 16 receives a wireless signal from the transmitter 28 of the power reception device 3, the receiver 16 extracts information representing a measurement value of the output voltage of the resonant circuit 20 of the power reception device 3 from the wireless signal, and outputs the information to the control circuit 18. Therefore, the receiver 16 includes, for example, an antenna for receiving the wireless signal in conformity with predetermined wireless communication standards, and a communication circuit for decoding the wireless signal. The predetermined wireless communication standards may be, for example, ISO/IEC 15693, ZigBee (trademark), or Bluetooth (trademark).

The gate driver 17 receives a control signal to switch the activation and deactivation of the switching elements 12-1 and 12-2 from the control circuit 18, and changes a voltage to be applied to the gate terminal of each of the switching elements 12-1 and 12-2 in accordance with the control signal. More specifically, upon receiving a control signal to turn on the switching element 12-1, the gate driver 17 applies a relatively high voltage to the gate terminal of the switching element 12-1 to turn on the switching element 12-1 and allow a current to flow from the DC power supply 11 through the switching element 12-1. Upon receiving a control signal to turn off the switching element 12-1, the gate driver 17 applies a relatively low voltage to the gate terminal of the switching element 12-1 to turn off the switching element 12-1 and interrupt the flow of current from flowing from the DC power supply 11 through the switching element 12-1. In the same manner, the gate driver 17 controls the voltage applied to the gate terminal of the switching element 12-2.

The control circuit 18 includes, for example, a nonvolatile memory circuit, a volatile memory circuit, an arithmetic circuit, and interface circuits to establish connection with other circuits. Whenever the control circuit 18 receives a measurement value of the output voltage from the receiver 16, the control circuit 18 controls the switching frequency of the power supply circuit 10 and the resonant circuit 13 in accordance with the measurement value.

Consequently, in the present embodiment, the control circuit 18 controls each of the switching elements 12-1 and 12-2, such that the switching elements 12-1 and 12-2 are turned on alternately, and the period of time in which the switching element 12-1 is turned on and the period of time in which the switching element 12-2 is turned on are equalized in one cycle corresponding to the switching frequency. Note that, in order to prevent a situation in which the switching elements 12-1 and 12-2 are concurrently turned on, whereby the DC power supply 11 short-circuits, the control circuit 18 may provide a dead time in which both switching elements are turned off when switching between the activation and deactivation of the switching elements 12-1 and 12-2.

Note that, the control of each of the switching elements 12-1 and 12-2 by the control circuit 18 will be described in detail later.

Next, the power reception device 3 will be described.

The resonant circuit 20 is an example of a first resonant circuit, and is an LC resonant circuit constituted of the reception coil 21 and the capacitor 22 connected in parallel with each other. One end of the reception coil 21 is connected to one end of the capacitor 22, and connected to one of input terminals of the rectifying and smoothing circuit 23. The other end of the reception coil 21 is connected to the other end of the capacitor 22, and connected to the other input terminal of the rectifying and smoothing circuit 23.

The reception coil 21 receives electric power from the transmission coil 15 by resonating with an AC current flowing through the transmission coil 15 of the power transmission device 2. The reception coil 21 outputs the received electric power to the rectifying and smoothing circuit 23 through the capacitor 22. Note that, the number of windings of the reception coil 21 may be the same as or different from the number of windings of the transmission coil 15 of the power transmission device 2. In the present embodiment, the inductance of each coil and the capacitance of each capacitor are set such that the resonant frequency of the resonant circuit 20 is higher than the resonant frequency of the resonant circuit 13 of the power transmission device 2. In other words, the inductance of each coil and the capacitance of each capacitor are set so as to satisfy the following equations.

$$\begin{matrix}[ Equation 1 ] & \\ {f}_{r 1} = \frac{1}{2 π \sqrt{{C}_{b} \cdot {L}_{1}}} & ( 1 ) \\ {f}_{r 2} = \frac{1}{2 π \sqrt{{C}_{p} \cdot {L}_{r 2}}} & \\ {L}_{r 2} = {L}_{2} ( 1 - k ) ( 1 + k ) & \end{matrix}$$

Wherein, C_{b} represents the capacitance of the capacitor 14, and L₁ represents the inductance of the transmission coil 15, and fᵣ₁ represents the resonant frequency of the resonant circuit 13. Cₚ represents the capacitance of the capacitor 22, and L₂ represents the inductance of the reception coil 21. Further, Lᵣ₂ represents the inductance of the reception coil 21 when the transmission coil 15 short-circuits, k represents the degree of coupling between the transmission coil 15 and the reception coil 21, and fᵣ₂ represents the resonant frequency of the resonant circuit 20. The inductance of each coil and the capacitance of each capacitor may be set so as to be, for example, fᵣ₁=10 kHz and fᵣ₂=100 kHz in the presumed degree of coupling (for example, k=0.1 to 0.5).

The capacitor 22 is connected to the reception coil 21 at one end, and connected to the rectifying and smoothing circuit 23 at the other end. The capacitor 22 outputs the electric power received by the reception coil 21 to the rectifying and smoothing circuit 23.

The rectifying and smoothing circuit 23, which includes a full-wave rectifying circuit 24 having four bridge-connected diodes and a smoothing capacitor 25, rectifies and smooths the electric power received by the reception coil 21 and the capacitor 22, and converts the electric power into DC power. The rectifying and smoothing circuit 23 outputs the DC power to the load circuit 26.

The voltage detection circuit 27 measures an output voltage across the terminals of the full-wave rectifying circuit 24 in predetermined cycles. Since the output voltage across the terminals of the full-wave rectifying circuit 24 corresponds to an output voltage of the resonant circuit 20 on a one-to-one basis, a measurement value of the output voltage across the terminals of the full-wave rectifying circuit 24 indirectly represents a measurement value of the output voltage of the resonant circuit 20. The voltage detection circuit 27 may be, for example, any of the various well-known types of voltage detection circuits that can detect DC voltage. Note that, the predetermined cycles are set, for example, longer than cycles corresponding to a presumed minimum value of the switching frequency of the resonant circuit 13 of the power transmission device 2, and set at, for example, 10 msec to 1 sec. The voltage detection circuit 27 outputs a voltage detection signal representing the measurement value of the output voltage to the transmitter 28.

Whenever the transmitter 28 receives the voltage detection signal from the voltage detection circuit 27, the transmitter 28 generates a wireless signal including information representing the measurement value of the output voltage represented by the voltage detection signal, and transmits the wireless signal to the receiver 16 of the power transmission device 2. Thus, the transmitter 28 includes, for example, a communication circuit for generating the wireless signal in conformity with predetermined wireless communication standards, and an antenna for outputting the wireless signal. The predetermined wireless communication standards may be, for example, ISO/IEC 15693, ZigBee (trademark), or Bluetooth (trademark), as in the case of the receiver 16. The information representing the measurement value of the output voltage may be, for example, the measurement value of the output voltage itself, or when the presumed range of the measurement value of the output voltage is divided into a plurality of ranks, information representing a rank to which the measurement value belongs. In this case, there are, for example, a rank of less than a reference voltage, a rank from the reference voltage to less than an upper limit voltage, and a rank of the upper limit voltage or more. Note that, the reference voltage and the upper limit voltage will be described later.

The operation of the non-contact power supply device 1 will be described below in detail.

In the present embodiment, the control circuit 18 of the power transmission device 2 controls the switching frequency, i.e., an on/off switching period, of each of the switching elements 12-1 and 12-2 within a predetermined frequency range, whenever the control circuit 18 receives the measurement value of the output voltage from the receiver 16. Note that, it is preferable that, for example, the predetermined frequency range is set so as to include the resonant frequency fᵣ₂ of the resonant circuit 20 of the power reception device 3 in the presumed degree of coupling, in order to enable reception of high electric power by the power reception device 3. In order to prevent an increase in the current flowing through the transmission coil 15 of the resonant circuit 13 of the power transmission device 2 to reduce energy transfer efficiency, the lower limit frequency of the predetermined frequency range is set higher than the resonant frequency fᵣ₁ of the resonant circuit 13.

As is apparent from Equation (1), the higher the degree of coupling k, the higher the resonant frequency fᵣ₂ of the resonant circuit 20 of the power reception device 3. The higher the resistance of the load circuit 26, the narrower the conduction angle of the diodes included in the full-wave rectifying circuit 24, and therefore the less the capacitance of the reception coil 21 has effect, thereby resulting in an increase in the resonant frequency fᵣ₂.

Accordingly, the lower limit frequency fmin of the predetermined frequency range can be set at, for example, the resonant frequency fᵣ₂ that corresponds to a minimum value of the presumed degree of coupling for performing power feeding and a minimum value of the presumed resistance of the load circuit 26. The upper limit frequency fmax of the predetermined frequency range is preferably set at a value higher than the resonant frequency fᵣ₂ that corresponds to a maximum value of the presumed degree of coupling and a maximum value of the presumed resistance of the load circuit 26. When the resistance of the load circuit 26 is constant or variation in the resistance of the load circuit 26 is negligible, the lower limit frequency fmin can be set at the resonant frequency fᵣ₂ that corresponds to the minimum value of the presumed degree of coupling.

The control circuit 18 controls the switching frequency such that the measurement value of the voltage by the voltage detection circuit 27 is brought close to the reference voltage, in order to suppress the current flowing through the transmission coil 15 and improve energy transfer efficiency. The reference voltage may be set at, for example, the output voltage of the resonant circuit 20 when the resonant frequency fᵣ₂ is equal to the lower limit frequency fmin.

To improve energy transfer efficiency, the power supply circuit 10 and the resonant circuit 13 of the power transmission device 2 preferably continue soft switching (inductive) operation. For the soft switching operation of the power supply circuit 10 and the resonant circuit 13, the phase of the current flowing through the transmission coil 15 is preferably delayed from the phase of the switching voltage. Therefore, for example, when the switching element 12-1 is turned on, a current flows from the source terminal to the drain terminal of the switching element 12-1, whereby the power supply circuit 10 and the resonant circuit 13 perform the soft switching operation, thus preventing the occurrence of a switching loss.

However, the higher the product (hereinafter referred to as kQ product) of the degree of coupling and a Q value of the reception coil 21 represented by the following Equation (2), the more the phase of a current flowing through the transmission coil 15 relatively proceeds.

$$\begin{matrix}[ Equation 2 ] & \\ Q = R \sqrt{\frac{{C}_{p}}{{L}_{r 2}}} & ( 2 )\end{matrix}$$

Wherein, R represents the resistance value of the load circuit 26. When the kQ product is higher than a predetermined value, the phase of the current flowing through the transmission coil 15 is earlier than the phase of the switching voltage and therefore, the power supply circuit 10 and the resonant circuit 13 perform hard switching (capacitive) operation. As a result, energy transfer efficiency deteriorates. In addition, the higher the kQ product, the higher the output voltage of the resonant circuit 20. Therefore, it is possible to recognize, based on the voltage measurement value by the voltage detection circuit 27, whether the power supply circuit 10 and the resonant circuit 13 are performing a soft switching operation or a hard switching operation.

In the present embodiment, the upper limit voltage Vth of the measurement value of the output voltage by the voltage detection circuit 27 is set in advance. The upper limit voltage Vth is set at a value obtained by subtracting a predetermined offset voltage from a maximum value of the output voltage across the terminals of the full-wave rectifying circuit 24, when the power supply circuit 10 and the resonant circuit 13 perform soft switching operation. For example, the predetermined offset voltage is obtained by multiplying the maximum value of the output voltage by 0.005 to 0.02. The control circuit 18 controls the switching frequency such that the measurement value of the output voltage by the voltage detection circuit 27 is equal to or less than the upper limit voltage Vth, and therefore, the power supply circuit 10 and the resonant circuit 13 can continue the soft switching operation, whereby a reduction in energy transfer efficiency is prevented.

Note that, the upper limit frequency fmax, the lower limit frequency fmin, the reference voltage Vr, and the upper limit voltage Vth are stored in advance in the nonvolatile memory of the control circuit 18.

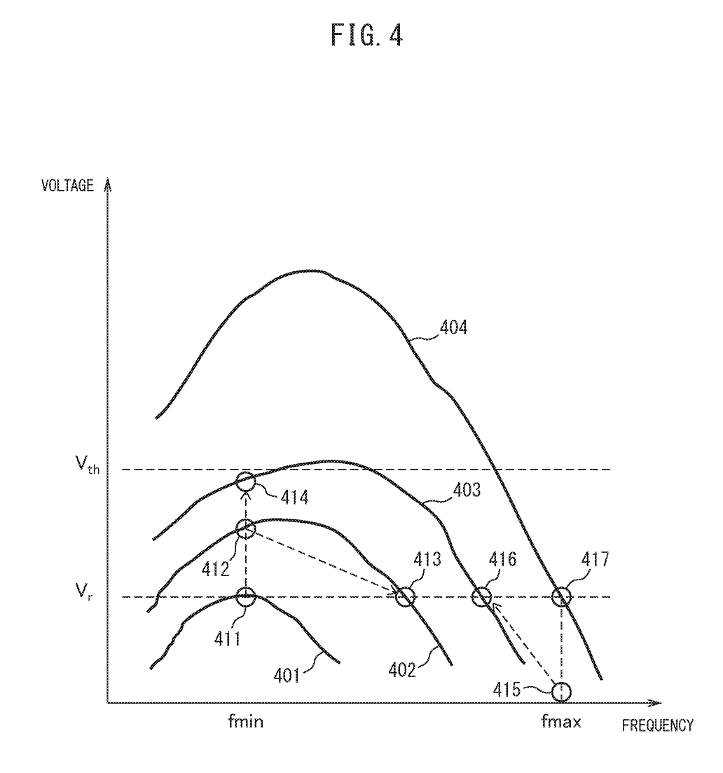

FIG. 4 is a view illustrating an example of the relationship between the control of the switching frequency and the frequency response of the output voltage on a degree of coupling basis. In FIG. 4, the horizontal axis represents frequency, and the vertical axis represents voltage. Graphs 401 to 404 represent the frequency responses of the output voltage across the terminals of the full-wave rectifying circuit 24 at degrees of coupling k1 to k4, respectively (k1<k2<k3<k4). The degree of coupling k1 is a minimum value of the presumed degree of coupling, and the degree of coupling k4 is a maximum value of the presumed degree of coupling.

When the degree of coupling between the transmission coil 15 and the reception coil 21 is k1, the control circuit 18 controls the switching frequency to be equal to the lower limit frequency fmin, so that the output voltage becomes the reference voltage Vr as illustrated in state 411, thus enabling power feeding to the power reception device 3 without a reduction in energy transfer efficiency. When the positional relationship between the power transmission device 2 and the power reception device 3 varies, and the degree of coupling changes from k1 to k2, even if the power supply circuit 10 and the resonant circuit 13 perform switching operation at the lower limit frequency fmin, as illustrated in a state 412, the output voltage rises. However, in this case, since the output voltage does not exceed the upper limit voltage Vth, as illustrated in state 413, the control circuit 18 can bring the output voltage closer to the reference voltage Vr by increasing the switching frequency by predetermined frequency variation amounts (for example, 5 kHz to 10 kHz).

On the other hand, when the positional relationship between the power transmission device 2 and the power reception device 3 varies and the degree of coupling changes from k1 to k3, as illustrated in state 414, the output voltage is close to the upper limit voltage Vth. Therefore, as the control circuit 18 increases the switching frequency by the predetermined frequency variation amounts, the output voltage exceeds the upper limit voltage Vth. Accordingly, when the measurement value of the output voltage reaches the upper limit voltage Vth, the control circuit 18 sets the switching frequency at the upper limit frequency fmax to decrease the output voltage. In this case, since the upper limit frequency fmax is higher than the resonant frequency of the resonant circuit 20, as illustrated in state 415, the output voltage becomes lower than the reference voltage Vr. Therefore, after the switching frequency is set at the upper limit frequency fmax, as illustrated in state 416, the control circuit 18 decreases the switching frequency by predetermined frequency variation amounts, until the measurement value of the output voltage reaches the reference voltage Vr.

When the positional relationship between the power transmission device 2 and the power reception device 3 varies and the degree of coupling changes from k1 to k4, the output voltage exceeds the upper limit voltage Vth. In this case, the control circuit 18 sets the switching frequency at the upper limit frequency fmax. As illustrated in state 417, the output voltage is thereby brought close to the reference voltage Vr.

Note that, when the measurement value of the output voltage is lower than the reference voltage Vr, the control circuit 18 may decrease the switching frequency by the predetermined frequency variation amounts, until the measurement value of the output voltage reaches the reference voltage Vr.

To summarize the above-described operation, when the measurement value of the output voltage by the voltage detection circuit 27 is lower than the reference voltage Vr, the control circuit 18 decreases the switching frequency by a predetermined frequency. Conversely, when the measurement value of the output voltage is higher than the reference voltage Vr and lower than the upper limit voltage Vth, the control circuit 18 increases the switching frequency by a predetermined frequency. When the measurement value of the output voltage is equal to or greater than the upper limit voltage Vth, the control circuit 18 sets the switching frequency at the upper limit frequency fmax. Note that, when the absolute value of the difference between the measurement value of the output voltage and the reference voltage Vr is within a predetermined allowable range (for example, ±3 to 5% of the reference voltage Vr), the control circuit 18 may not change the switching frequency.

In addition, by making the switching frequency lower than the resonant frequency fᵣ₂ of the resonant circuit 20 of the power reception device 3, the output voltage of the resonant circuit 20 and the output voltage across the terminals of the full-wave rectifying circuit 24 decrease. Therefore, according to a modification example, the upper limit frequency fmax of the frequency range in which the switching frequency is adjusted may be set at the resonant frequency fᵣ₂ of the resonant circuit 20 of the power reception device 3, at the minimum value of the presumed degree of coupling. In this case, the lower limit frequency fmin of the frequency range also is set at a value higher than the resonant frequency fᵣ₁ of the resonant circuit 13 of the power transmission device 2. In this case, when the degree of coupling increases and the measurement value of the output voltage therefore is higher than the reference voltage Vr, the control circuit 18 decreases the switching frequency by predetermined frequency variation amounts. When the measurement value of the output voltage reaches the upper limit voltage Vth, the control circuit 18 sets the switching frequency at the lower limit frequency fmin. When the measurement value of the output voltage is lower than the reference voltage Vr, the control circuit 18 may increase the switching frequency by predetermined frequency variation amounts.

As described above, the non-contact power supply device prevents an increase in current flowing through the transmission coil by setting the circuit element constants of the individual resonant circuits such that the resonant frequency of the resonant circuit of the power reception device is higher than the resonant frequency of the resonant circuit of the power transmission device. The non-contact power supply device monitors the output voltage of the resonant circuit of the power reception device, and controls the switching frequency to make the output voltage lower than the upper limit voltage to enable continuation of the soft switching operation of the power supply circuit and the resonant circuit of the power transmission device. Furthermore, the non-contact power supply device enables continuous operation of the power transmission device at a switching frequency that is close to the resonant frequency of the resonant circuit of the power reception device, by controlling the switching frequency such that the measurement value of the output voltage is brought close to the output voltage when the resonant circuit of the power reception device resonates. Therefore, the non-contact power supply device can prevent a reduction in energy transfer efficiency, even if the degree of coupling between the transmission coil and the reception coil dynamically changes.

According to a modification example, the voltage detection circuit 27 may measure an output voltage across terminals of the smoothing capacitor 25. In this case, one terminal of the voltage detection circuit 27 may be connected between one end of the smoothing capacitor 25 and one end of the load circuit 26, and the other terminal of the voltage detection circuit 27 may be connected between the other end of the smoothing capacitor 25 and the other end of the load circuit 26.

When the voltage detection circuit 27 is capable of measuring AC voltage, the voltage detection circuit 27 may directly measure the output voltage across output terminals of the resonant circuit 20.

According to another modification example, the larger the absolute value of the difference between the measurement value of the output voltage and the reference voltage, the more the control circuit 18 may increase a variation amount of the switching frequency. As a result, the control circuit 18 can bring the output voltage close to the reference voltage in a short time.

Furthermore, in the power transmission device 2, a power supply circuit for supplying AC power to the resonant circuit 13 may have a different circuit configuration from the above embodiment, as long as the circuit can variably adjust the switching frequency.

When the receiver 16 of the power transmission device 2 and the transmitter 28 of the power reception device 3 can be connected through a wire, each of the receiver 16 and the transmitter 28 may include a communication circuit that can communicate a signal including information representing the measurement value of the output voltage through the wire.

As described above, a person skilled in the art can make various modifications in accordance with embodiments within the scope of the present invention.

### REFERENCE SIGNS LIST

1 non-contact power supply device
2 power transmission device
10 power supply circuit
11 dc power supply
12-1, 12-2 switching element
13 resonant circuit
14 capacitor
15 transmission coil
16 receiver
17 gate driver
18 control circuit
3 power reception device
20 resonant circuit
21 reception coil
22 capacitor
23 rectifying and smoothing circuit
24 full-wave rectifying circuit
25 smoothing capacitor
26 load circuit
27 voltage detection circuit
28 transmitter

1. A non-contact power supply device comprising a power transmission device and a power reception device to which electric power is contactlessly transferred from the power transmission device, wherein
the power reception device comprises:
a first resonant circuit which includes a reception coil for receiving the electric power from the power transmission device, and a first resonant capacitor connected in parallel with the reception coil, and resonates at a first frequency;
a voltage detection circuit which measures an output voltage from the first resonant circuit to obtain a measurement value of the output voltage; and
a transmitter which transmits a signal including information representing the measurement value of the output voltage to the power transmission device, and
the power transmission device comprises:
a second resonant circuit which includes a transmission coil for supplying the electric power to the power reception device, and a second resonant capacitor connected in series with the transmission coil, and resonates at a second frequency lower than the first frequency;
a power supply circuit which supplies AC power having an adjustable switching frequency to the second resonant circuit;
a receiver which receives the signal including the information representing the measurement value of the output voltage; and
a control circuit which controls the switching frequency in accordance with the measurement value of the output voltage, such that the second resonant circuit and the power supply circuit continue soft switching operation.

2. The non-contact power supply device according to claim 1, wherein the control circuit controls the switching frequency within a frequency range that includes the first frequency in a presumed degree of coupling between the transmission coil and the reception coil and does not include the second frequency in the presumed degree of coupling.

3. The non-contact power supply device according to claim 2, wherein
the frequency range is set such that a lower limit frequency of the frequency range coincides with the first frequency at a minimum value of the presumed degree of coupling, and
when the measurement value of the output voltage exceeds a first voltage, the control circuit sets the switching frequency at an upper limit frequency of the frequency range.

4. The contactless power feeing system according to claim 1, wherein the control circuit controls the switching frequency so as to reduce the difference between the measurement value of the output voltage and the output voltage when the first resonant circuit resonates.

5. The contactless power feeing system according to claim 2, wherein the control circuit controls the switching frequency so as to reduce the difference between the measurement value of the output voltage and the output voltage when the first resonant circuit resonates.

6. The contactless power feeing system according to claim 3, wherein the control circuit controls the switching frequency so as to reduce the difference between the measurement value of the output voltage and the output voltage when the first resonant circuit resonates.
